(19) United States
(12) Patent Application Publication
(10) Pub. No.: US 2007/0061314 A1
(43) Pub. Date: Mar. 15, 2007

(54) VERBAL WEB SEARCH WITH IMPROVED ORGANIZATION OF DOCUMENTS BASED UPON VOCAL GENDER ANALYSIS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/562,036

(22) Filed: Nov. 21, 2006

Related U.S. Application Data
(63) Continuation-in-part of application No. 11/341,021, filed on Jan. 27, 2006.
(63) Continuation-in-part of application No. 11/298,797, filed on Dec. 9, 2005.
(60) Provisional application No. 60/754,387, filed on Dec. 27, 2005.
(60) Provisional application No. 60/649,240, filed on Feb. 1, 2005.
(60) Provisional application No. 60/755,558, filed on Dec. 29, 2005.

(51) Int. Cl. G06F 17/30

(52) U.S. Cl. 707/3

(57) ABSTRACT

A computer implemented method of organizing a set of documents, comprising receiving verbal utterances from a user; processing the verbal utterances using gender analysis routines, thereby determining a verbally identified gender of the user; processing the verbal utterances using speech recognition routines, thereby determining the content of a search query uttered by the user; identifying a set of documents responsive to the search query based at least in part upon the content of the search query uttered by the user; assigning a score to each identified document based upon a correlation between gender-usage data for each document in the set and the verbally identified gender of the user, the gender-usage data describing at least one of a number and frequency of users who have previously accessed the document who are of a particular gender; and organizing the documents based at least in part on the assigned score.

This application is a continuation-in-part of U.S. application Ser. No. 11/341,021 filed Jan. 27, 2006, which claims the benefit of U.S. Provisional Application No. 60/754,387 filed Dec. 27, 2005, and which is a continuation-in-part of U.S. application Ser. No. 11/298,797 filed Dec. 9, 2005, which claims the benefit of U.S. Provisional Application No. 60/649,240 filed Feb. 1, 2005, all of which are incorporated in their entirety herein by reference.

This application also claims the benefit of U.S. Provisional Application No. 60/755,558 filed Dec. 29, 2005, which is incorporated in its entirety herein by reference.

This application also relates to U.S. application Ser. No. 11/282,379 filed Nov. 18, 2005, which claims the benefit of U.S. Provisional Application No. 60/653,975 filed Feb. 16, 2005, both of which are incorporated in their entirety herein by reference.

### BACKGROUND OF THE INVENTION

1. Field of the Invention

The present invention relates generally to internet search engines and, more particularly, to employing data related to a user's gender to improve information search, retrieval, and organization, during internet searching.

2. Discussion of the Related Art

The World Wide Web (“web”) contains a vast amount of information. Locating a desired portion of the information, however, can be challenging. This problem is compounded because the amount of information on the web and the number of new users who are inexperienced at web research is growing rapidly.

People generally surf the web based on its link graph structure, often starting with high quality human-maintained indices or use search engines such as Google or Yahoo. Human-maintained lists cover popular topics effectively but are subjective, expensive to build and maintain, slow to improve, and do not cover all esoteric topics.

Automated search engines, in contrast, locate web sites by matching search terms entered by the user to an indexed corpus of web pages. Generally, the search engine returns a list of web sites sorted based on relevance to the user's search terms. Determining the correct relevance, or importance, of a web page to a user, however, can be a difficult task. For one thing, the importance of a web page to the user is inherently subjective and depends on the user's interests, knowledge, and attitudes. There is, however, much that can be determined objectively about the relative importance of a web page.

Conventional methods of determining relevance are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. Another known method is disclosed in U.S. Patent Publication No. 2002/0123988 as published on Sep. 5, 2002 and is hereby incorporated by reference into this specification.

Each of these conventional methods has shortcomings, however. Term-based methods are biased towards pages whose content or display is carefully chosen towards the given term-based method. Thus, they can be easily manipulated by the designers of the web page. Link-based methods have the problem that relatively new pages have usually fewer hyperlinks pointing to them than older pages, which tends to give a lower score to newer pages. There exists, therefore, a need to develop other techniques for determining the importance of documents when ordering documents in response to a search query.

In addition, conventional methods do not account for statistically predictable similarities and/or differences between users who initiate a search when ordering the results for those users. For example, a user of a particular gender is likely to prefer different documents in response to a search query as compared to a user of the opposite gender who enters the same search query. For example, a male user searching the phrase “exercise” is likely to prefer different documents than a female user searching the same phrase. This is because same gender users are more likely to have similar perspectives and interests with respect to certain topics as compared to different gender users. There exists, therefore, a substantial need to develop new techniques for ordering documents that account for statistically predictable similarities and/or differences between users based upon their gender. Furthermore, a typical search engine may not have readily available access to gender information about the user performing the search. Furthermore if a user does provide gender information, there is no guarantee that the information is truthful. Thus there exists a need for inventive methods of gathering and using gender information about a user who is performing a web search without requiring the user to manually enter gender data, a step the user may not wish to spend time on or may not do truthfully.

### SUMMARY OF THE INVENTION

Several embodiments of the invention advantageously address the needs above as well as other needs by providing methods and apparatus for using data related to a user's gender to improve the organization of documents retrieved in response to a search query.

In one embodiment, the invention can be characterized as a computer implemented method of organizing a set of documents, comprising receiving verbal utterances from a user; processing the verbal utterances using gender analysis routines, thereby determining a verbally identified gender of the user; processing the verbal utterances using speech recognition routines, thereby determining the content of a search query uttered by the user; identifying a set of documents responsive to the search query based at least in part upon the content of the search query uttered by the user; assigning a score to each identified document based upon a correlation between gender-usage data for each document in the set and the verbally identified gender of the user, the gender-usage data describing at least one of a number and frequency of users who have previously accessed the document who are of a particular gender; and organizing the documents based at least in part on the assigned score.

In another embodiment, the invention can be characterized as a an apparatus for organizing a collection of documents comprising circuitry having executable instructions; and at least one processor configured to execute the program instructions to perform operations of receiving verbal utterances from a user; processing the verbal utterances using gender analysis routines, thereby determining a verbally identified gender of the user; processing the verbal utterances using speech recognition routines, thereby determining the content of a search query uttered by the user; identifying a set of documents responsive to the search query based at least in part upon the content of the search query uttered by the user; assigning a score to each identified document based upon a correlation between gender-usage data for each document in the set and the verbally identified gender of the user, the gender-usage data describing at least one of a number and frequency of users who have previously accessed the document who are of a particular gender; and organizing the documents based at least in part on the assigned score.

In a further embodiment, the invention may be characterized as a computer implemented method of organizing a set of documents, comprising receiving verbal utterances from a user; processing the verbal utterances using gender analysis routines, thereby determining an verbally identified gender of the user; receiving a search query from a user in either a verbal or textual form; identifying a set of documents responsive to the search query; assigning a score to each identified document based upon a correlation between gender-usage data for each document in the set and the verbally identified gender of the user, the gender-usage data describing the prior usage of the document by users who are of a particular gender; and organizing the documents based at least in part on the assigned score.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an exemplary network in which concepts consistent with the present invention may be implemented;

FIG. 2 illustrates an exemplary client device of the present invention;

FIG. 3 illustrates a flow diagram, consistent with the invention, for organizing documents based in part on gender information;

FIG. 4 illustrates a few techniques for computing the frequency of visits, consistent with the invention including a standard count and a gender count and/or an age count;

FIG. 5 illustrates a few techniques for computing the number of unique users, consistent with the invention; and a standard count and a gender count and/or an age count;

FIG. 6 depicts an exemplary method, consistent with the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Consistent with numerous embodiments of the present invention, methods and apparatus described herein use data related to a user's gender to better organize the search results presented to that user. In particular, methods and apparatus described herein utilize the user's voice to determine the user's gender.

In one embodiment, a user verbally utters a search query to computer system, the search query being received by a microphone and processed by a speech recognition system. The output of the speech recognition system is the verbally uttered search query converted into a textual and/or other symbolic form. The textual or other symbolic representation of the search query is then input into the search engine of the present invention. The search query is received and a list of responsive documents is identified. The list of responsive documents may be based on a comparison between the content of the search query and the contents of the documents, or by other conventional methods.

Speech recognition systems capable of converting a user's verbal utterance into a textual and/or other symbolic form are known to the art. Such systems that capture a user's voice through a microphone, digitize the audio signal, process the digitized signal, and determine the words and phrases uttered by the user. One example of such a speech recognition system is disclosed in U.S. Pat. No. 6,804,643 which is hereby incorporated by reference. As disclosed in this patent, prior art speech recognition systems consist of two main parts: a feature extraction (or front-end) stage and a pattern matching (or back-end) stage. The front-end effectively extracts speech parameters (typically referred to as features) relevant for recognition of a speech signal. The back-end receives these features and performs the actual recognition. In addition to reducing the amount of redundancy of the speech signal, it is also very important for the front-end to mitigate the effect of environmental factors, such as noise and/or factors specific to the terminal and acoustic environment.

The task of the feature extraction front-end is to convert a real time speech signal into a parametric representation in such a way that the most important information is extracted from the speech signal. The back-end is typically based on a Hidden Markov Model (HMM), a statistical model that adapts to speech in such a way that the probable words or phonemes are recognized from a set of parameters corresponding to distinct states of speech. The speech features provide these parameters. It is possible to distribute the speech recognition operation so that the front-end and the back-end are separate from each other, for example the front-end may reside in a mobile telephone and the back-end may be elsewhere and connected to a mobile telephone network. Similarly the front end may be in a computer local to the user and the back-end may be elsewhere and connected by a network, for example by the internet, to said local computer.

Thus the speech recognition system of the present invention may take a variety of forms and may be distributed across a number of processors, some local and some on a networked server. Alternately the client machine that the user is interacting with may perform all the speech recognition tasks. Either way, the output of the speech recognition system is a textual and/or other symbolic representation of the query uttered by the user. The query may be further processed by the routines of the present invention to eliminate search related verbs in the verbal utterance such as “find” or “look for” or “search under” or “get me” or “pull up” or “access” or “what is”. What are generally left are the key words and/or phrases with which the search engine will perform the search in a textual or other symbolic form. This textual or other symbolic representation of the search query is then input into the search engine of the present invention. The search query is received by the search engine and a list of responsive documents is identified.

In addition to the speech recognition performed upon the verbal utterance, a gender recognition routine is also employed to process the verbal utterance captured from the user. A number of systems and methods are known to the art for identifying the gender of a person by capturing and processing that person's vocalizations using software routines. For example, the 1991 papers “Gender recognition from speech. Part I: Coarse analysis” published in the Journal of the Acoustical Society of America and “Gender recognition from speech. Part II: fine analysis,” also published in the Journal of the Acoustical Society of America, both by Wu K, and Childers DG., together disclose computer automated methods of identifying the gender of a person based upon the digital processing of recorded signals representing their speech. Both of these papers are hereby incorporated by reference. In addition a system disclosed in pending U.S. Patent Publication No. 2003/0110038, which is hereby incorporated by reference, provides methods and apparatus for determining a user's gender based upon an analysis of verbal utterances of the user in combination with an analysis of a visual image captured by a camera of the user. To employ such methods within the present invention a digital camera may be used in combination with the microphone described previously to capture not just the user's voice but also a visual image of the user who utters the search query.

A number of other systems and methods are known to the art for identifying the gender of a person from video images using computer vision and image processing techniques. For example, the paper “Identity and Gender Recognition Using the ENCARA Real-Time Face Detector” by M. Castrillon, O. Deniz, D. Hernandez, and A. Dominguez discloses methods of using real-time image detection and processing techniques to identify the gender of a user based upon a video image of their face. This paper is hereby incorporated by reference. Other methods have been developed for identifying gender of a user based upon processed video images of the user's face. For example, the paper “A Method for Estimating and Modeling Age and Gender using Facial Image Processing” by J. Hayashi, M. Yasumoto, H. Ito, and H. Koshimizu was published in 2001 in the Seventh International Conference on Virtual Systems and Multimedia (VSMM'01). This paper is hereby incorporated by reference.

Thus by performing a gender determination analysis upon a spoken utterance of the user who performs the search query, alone or in combination with an image analysis of a captured facial image of the user, a predicted gender for the user is identified. Because the predicted gender is determined at least in part based upon an analysis of a user's spoken verbalization, the gender determination is referred to herein as the Verbally Identified Gender. In one embodiment the Verbally Identified Gender of the user is a single binary variable indicating male or female. In other embodiments the Verbally Identified Gender may also include a Gender Confidence Value that indicates a degree of confidence in the gender determined based upon an analysis of the users voice.

In addition the Verbally Identified Gender may include a Gender Correlation Factor that indicates the degree of statistical relevance that gender has for predicting the document preference for that particular user. In one such embodiment the Gender Correlation Factor is a number between 0 and 1 that indicates a degree of statistical relevance that gender has to document preference for that user. For example, in some users gender may be highly relevant in predicting the documents that the user may prefer. For such a user, the Gender Correlation Factor may be set to 0.90 for example. In other users, gender may be mildly relevant in predicting the documents that a user may prefer. For such a user the Gender Correlation Factor may be set to 0.27 for example. In other users, gender may be inversely correlated with the typically predicted documents that a user may prefer. For such a user the Gender Correlation Factor may be set to −0.33 for example, indicating that the user's preference is mildly correlated to the opposite gender indicated by Verbally Identified Gender data. In other embodiments, no Gender Correlation Factor is used.

In addition to the steps above, the current invention also include additional methods and systems for storing and processing data related to web page usage. Typically usage data includes information about a web page that describes how many users visited the page (perhaps over a period of time) and/or how often users visited the page (perhaps over a period of time). As disclosed in this invention, a new form of usage data referred to herein as Gender Usage Data is employed. Gender Usage Data not only represent how often a particular web page is accessed, but also records how often the web page is accessed by users of each gender. In this way the power of usage data can be substantially expanded, recording not just how often a web page is accessed, but how often it is accessed by male users and how often it is accessed by female users.

In one particular embodiment, Gender Usage Data is represented as a single variable that indicates the percentage of users who visit the site that are of a particular gender. Because there are only two genders, MALE or FEMALE, either may be chosen as the basis for this variable with the understanding that the remaining percentage of users are of the other gender. For example, a single variable PERCENT_MALE may be used that indicates the percentage of users who visit a particular document who are male. If this value was computed as 64% it can be inferred that the remaining 36% of visitors are female. In this way a single variable can represent the percentage of male and female visitors. The PERCENT_MALE variable may be computed based upon the number of visitors or the frequency of visitors. The PERCENT_MALE variable may be computed for visitors over a particular period of time, for example over the last 24 hours, over the last seven days, or over the last six months. In some embodiments multiple variables are computed using the number of visitors, the frequency of visitors, and/or different lengths of time for which the visits occurred.

In other embodiments a different single variable is used that represents the ratio of male to female visitors. For example a single variable GENDER_RATIO may be defined that is the number of male visitors over a particular period of time divided by the number of female visitors over that period of time. Alternately, the GENDER_RATIO may be defined as the frequency of male visitors over a particular period of time divided by the frequency of female visitors over a particular period of time.

In some embodiments there may actually be three different gender possibilities for a visitor to a particular document—male, female, and unknown. Such embodiments are possible because some users may choose not to identify their gender when performing a search. For such embodiments, a number of different techniques may be used for computing Gender Usage Data. In one such embodiment, the Gender Usage Data values are computed based only upon the visitors of known gender. For example, the PERCENT_MALE may be computed as described above, but using the percentage of known male visitors divided by the total sum of known male and known female visitors. Similarly, the GENDER_RATIO may be computed as described above, but using the number of known male visitors divided by the number of known female visitors.

In some embodiments, using only the known male visitors and the known female visitors to compute the Gender Usage Data statistics may provide distorted statistics. This is because in some situations, one gender may be statistically more likely to disclose their gender than the other gender. For example, if more males disclosed their gender than females, the PERCENT_MALE or GENDER_RATIO values as described above would be distorted to indicate a greater male gender preference to a document than is actually true. This is because a larger percentage of female visitors would go uncounted in such a situation. To account of this, some embodiments of the present invention may employ a gender correction value that is used to correct for differences in male and female gender disclosure tendencies. For example, if it is determined through historical analysis that a male user is 20% more likely to disclose his gender than a female user, the count of female users (in number or frequency) may be multiplied by a Gender Correction Value equal to 1.2. In this way, the number of female users is increased to represent the fact that a larger percentage of female users are in the unknown group. Once this correction value is used to adjust the number of female users, the PERCENT_MALE or GENDER_RATIO values may be computed as described above with likely greater accuracy with respect to the known and unknown values.

By determining and storing Gender Usage Data as described in the paragraphs above, the methods and systems disclosed herein can further optimize the ordering of search results for a given user based upon that user's Verbally Identified Gender. For example if a user makes a query to the search methods and systems disclosed herein, and that user has Verbally Identified Gender data that identifies him or her as MALE, the ordering of search results presented to that user may then be based in whole or in part upon the frequency and/or number of times that other users who are also identified as MALE have accessed a given web page. In this way, the Verbally Identified Gender data of the user can be used in conjunction with Gender Usage Data to better order and present search results to that user.

Another aspect of the present invention is directed to a method of predicting the gender of a particular user based at least in part upon both (a) a gender analysis of the user's voice as described above and (b) determined correlations between that user's document preferences and stored Gender Usage Data for a plurality of documents. By using these two methods in combination a user's gender may be more accurately determined than by using voice analysis alone.

A. Architecture

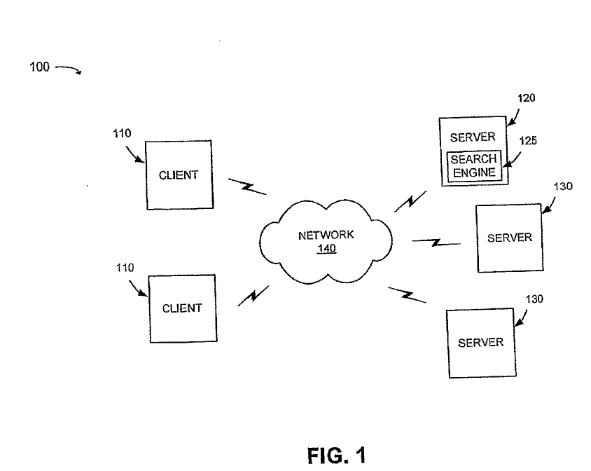

FIG. 1 illustrates a system 100 in which methods and apparatus, consistent with the present invention, may be implemented. The system 100 may include multiple client devices 110 connected to multiple servers 120 and 130 via a network 140. The network 140 may include a local area network (LAN), a wide area network (WAN), a telephone network, such as the Public Switched Telephone Network (PSTN), an intranet, the Internet, or a combination of networks. Two client devices 110 and three servers 120 and 130 have been illustrated as connected to network 140 for simplicity. In practice, there may be more or less client devices and servers. Also, in some instances, a client device may perform the functions of a server and a server may perform the functions of a client device.

The client devices 110 may include devices, such mainframes, minicomputers, personal computers, laptops, personal digital assistants, cell phones, or the like, capable of connecting to the network 140. The client devices 110 may transmit data over the network 140 or receive data from the network 140 via a wired, wireless, or optical connection.

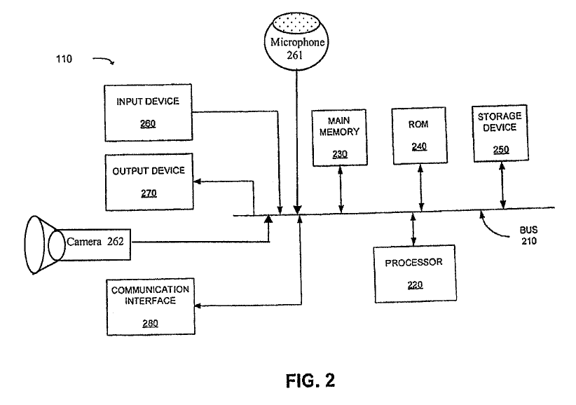

FIG. 2 illustrates an exemplary client device 110 consistent with the present invention. The client device 110 may include a bus 210, a processor 220, a main memory 230, a read only memory (ROM) 240, a storage device 250, an input device 260 (such as a keyboard, mouse, trackball, and/or touch screen), an output device 270 (such as a monitor and/or speakers), and a communication interface 280. Specifically the client includes at least one microphone 261 that enables audio sounds (i.e. spoken vocalizations) from the user to be captured as part of a speech recognition system and/or gender recognition system as described previously. The captured voice from the microphone is generally converted to digital data through an A/D converter (not shown) or other piece of hardware or software that performs a similar function. The captured sound from the microphone may be filtered, processed for noise reduction, or otherwise modified for improved speech recognition and/or gender recognition as described previously.

The client may also include a camera 262 that is aimed and configured such that it may capture a facial image of the user as the user interacts with the client machine. The facial image of the user may be used as part of the gender recognition process of the present invention as described previously. A variety of techniques may be used for enhancing and/or supporting the determination of the user's gender based upon a facial image captured by camera 262, including pattern matching techniques.

The bus 210 may include one or more conventional buses that permit communication among the components of the client device 110. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive. The storage device 250 may include audio samples and/or image samples used in pattern matching techniques for audio-based gender recognition processes and/or image-based gender recognition processes respectively.

The input device 260 may include one or more conventional mechanisms that permit a user to input information to the client device 110, such as a keyboard, a mouse, a pen, a trackball, a touch screen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 110 to communicate with other devices and/or systems. For example, the communication interface 280 may include mechanisms for communicating with another device or system via a network, such as network 140.

As will be described in detail below, the client devices 110, consistent with the present invention, may perform certain document retrieval operations in combination with server 120. The client devices 110 may perform these operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry may be used in place of or in combination with software instructions to implement processes consistent with the present invention. Thus, the present invention is not limited to any specific combination of hardware circuitry and software.

The servers 120 and 130 may include one or more types of computer systems, such as a mainframe, minicomputer, or personal computer, capable of connecting to the network 140 to enable servers 120 and 130 to communicate with the client devices 110. In alternative implementations, the servers 120 and 130 may include mechanisms for directly connecting to one or more client devices 110. The servers 120 and 130 may transmit data over network 140 or receive data from the network 140 via a wired, wireless, or optical connection.

The servers may be configured in a manner similar to that described above in reference to FIG. 2 for client device 110. In an implementation consistent with the present invention, the server 120 may include a search engine 125 usable by the client devices 110. The servers 130 may store documents (or web pages) accessible by the client devices 110 and may perform document retrieval and organization operations, as described below.

B. Architectural Operation

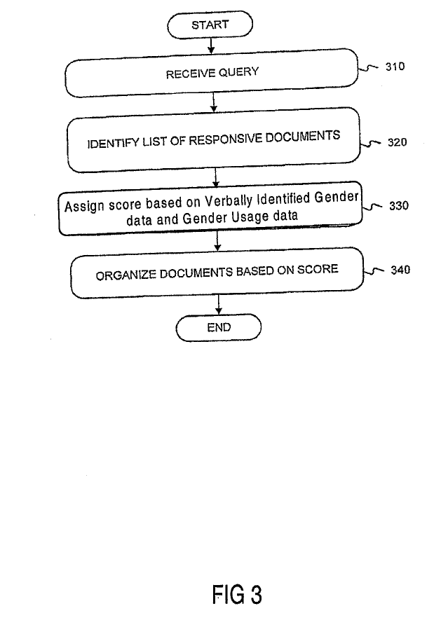

FIG. 3 illustrates a flow diagram, consistent with the invention, for organizing documents based on both Verbally Identified Gender related to the user who performs a search and Gender Usage data related to the web documents that are retrieved during the search. At stage 310, a search query is received by search engine 125 as entered by said user. As described previously, this search query may be verbally uttered and converted to a textual or other symbolic form by a speech recognition system. At stage 320, search engine 125 identifies a list of documents that are responsive (or relevant) to the search query. This identification of responsive documents may be performed in a variety of ways, consistent with the invention, including conventional ways such as comparing the search query to the content of the document.

Once this set of responsive documents has been determined, it is necessary to organize the documents in some manner. Consistent with the invention, this organization of responsive documents may be achieved by employing Verbally Identified Gender data, in whole or in part. As described previously, the Verbally Identified Gender is derived from audio and/or video image data collected form said user through a microphone and/or digital camera interfaced to the client machine, the audio and/or video image data being processed by gender recognition routines of the present invention. Consistent with the invention the organization of responsive document may also be achieved also by employing Gender Usage data, in whole or in part. In the particular embodiment represented by FIG. 3, the organization of responsive document is achieved at least in part by employing both Verbally Identified Gender data and Gender Usage data.

As shown at stage 330, scores are assigned to each document based upon how well the Gender Usage data for a particular document correlates with the Verbally Identified Gender data of the user who is performing the search. The scores may be absolute in value or relative to the scores for other documents. The scores are weighed based upon the level or degree of correlation determined. For example, a web site that has Gender Usage data that shows heavy usage by male users as compared to female users will be determined to correlate strongly with a user who has a Verbally Identified Gender as male. Alternately, a web site that has Gender Usage data that shows low usage by male users as compared to female users will be determined to correlate weakly with a user who has an Verbally Identified Gender as male. In this way, a higher score can be assigned to a document that shows a strong correlation between Gender Usage Data and Verbally Identified Gender as compared to a document that shows weaker correlation between Gender Usage Data and Verbally Identified Gender. In addition, a Gender Correlation Factor may be taken into account in the computation of such scores. For example, a user that has a high Gender Correlation Factor may have a greater difference in computed scores based upon the correlation between Gender Usage data and Verbally Identified Gender as compared to a user who has a low Gender Correlation Factor value associated with him or her. And in some cases, an inverse Gender Correlation Factor may be used to reverse the scoring method, awarding a higher score for a weaker gender correlation and a lower score for a stronger gender correlation. In this way the documents may be scored based upon the correlation between Verbally Identified Gender of the user and the Gender Usage data for the document, with optional consideration of a Gender Correlation Factor that represents the predictive value of gender correlation for the particular user who performed the search.

As a means of further example, in one exemplary embodiment a search query is verbally entered by a user who is identified as MALE (i.e. Verbally Identified Gender=MALE) as a result of the gender processing of a verbally spoken search query of the user captured by a microphone of the inventive system and/or as a result of the gender processing of a facial image of the user captured by a camera of the inventive system. In response to the determined content of the search query, the search engine finds a number of documents. One particular document has Gender Usage Data that indicates that the percentage of male users (i.e. PERCENT_MALE) is computed as 82%. Another particular document has Gender Usage Data that indicates that the percentage of male users is computed as 21%. Thus the first aforementioned document has a strong correlation between Gender Usage data and the Verbally Identified Gender of the user and the second aforementioned document has a weak correlation between the Gender Usage Data and the Verbally Identified Gender of the user. The first document is therefore assigned a higher score in stage 330 than the second document. In some embodiments a scoring method may be employed in which the percentage of visitors in the Usage Data who are of the user's gender is translated directly into a score value. For example, the first document may be assigned a score of 82 while the second document may be assigned as a score of 21. In this embodiment Gender Correlation Factor is not used. In fact, in many embodiments this value is used in later stages wherein the affect of gender is weighted with respect to other factors that may influence the ordering of documents.

Thus returning attention to FIG. 3, the process of assigning a score at stage 330 can be based on a variety of Gender Usage data and Verbally Identified Gender data. In a preferred implementation, the Gender Usage data comprises information about both the number of unique visits and the frequency of visits of users of particular genders. For example said Gender Usage data may in some embodiments include data about not only how many unique visitors of a particular gender have visited a site during a particular time period, but also the frequency. The correlations can be stored as absolute numbers or as relative percentages.

The Gender Usage Data and Verbally Identified Gender data may be maintained at client device 110 and transmitted to search engine 125. Alternately the Gender Usage Data may be maintained upon a server 130 and the Verbally Identified Gender data may be maintained upon client device 110. Alternately both Gender Usage Data and Verbally Identified Gender data may be maintained upon a server 130. The location of the gender information is not critical, however, and it could also be maintained in other ways. For example, the gender usage data may be maintained at servers 130, which forward the information to search engine 125; or the usage information may be maintained at server 120 if it provides access to the documents (e.g., as a web proxy).

At stage 340, the responsive documents are organized based on the assigned scores. The documents may be organized based entirely on the scores derived from Gender Usage data of the retrieved web pages and the Verbally Identified Gender of the user who has initiated the search. Alternatively, they may be organized based on the assigned scores in combination with other factors. For example, the documents may be organized based on the assigned scores combined with link information and/or query information. Link information involves the relationships between linked documents, and an example of the use of such link information is described in the Brin & Page publication referenced above. Query information involves the information provided as part of the search query, which may be used in a variety of ways to determine the relevance of a document. Other information, such as the length of the path of a document, could also be used. In addition, the relative importance of the gender score with the other factors used in ordering the documents is a variable that may be set, assigned, or derived.

In some preferred embodiments of the present invention, the relative importance of gender score as compared to other factors used in ordering the document is based in whole or in part upon a Gender Correlation Factor value that is relationally associated with the user who performed the search. In such embodiments the affect that gender score has upon ordering of the document as compared to the affect that other factors have upon ordering of the documents is dependent upon the Gender Correlation Factor, the higher the Gender Correlation Factor, the greater the affect that gender score has as compared to other factors used in ordering.

In some preferred embodiments of the present invention, the relative importance of gender score as compared to other factors used in ordering the document is based in whole or in part upon a Gender Confidence Value that is relationally associated with the user who performed the search. The Gender Confidence Value is a value that indicates a degree of confidence in the gender determination of the user. The Gender Confidence Value may reflect a degree of confidence resulting from the gender determination analysis performed upon the voice of the user and/or performed upon facial image of the user as described previously. In such embodiments the affect that gender score has upon ordering of the document as compared to the affect that other factors have upon ordering of the documents is dependent upon the Gender Confidence Value, the higher the Gender Confidence Value, the greater the affect that gender score has as compared to other factors used in ordering.

In one implementation, documents are organized based on a total score that represents the product of a Gender Usage score and a standard query-term-based score (“IR score”). The Gender Usage score may be weighted based upon the Gender Correlation Factor and/or the Gender Confidence Value prior to computation of the total score. In some embodiments the total score equals the square root of the IR score multiplied by the weighted Gender Usage score. The Gender Usage score, in turn, equals a frequency of visit score (weighed by a degree of correlation with Verbally Identified Gender of the user) multiplied by a unique user score (also weighed by a degree of correlation with Verbally Identified Gender) multiplied by a path length score (optionally weighted by a degree of correlation with Verbally Identified Gender).

In one embodiment a first frequency of visit score equals log 2(1+log(VF)/log(MAXVF). VF is the number of times that the document was visited (or accessed) in one month, and MAXVF is set to 2000. In this embodiment a second frequency of visit score is calculated not based upon the total number of visits, but calculated based upon a correlation with the searching user's Verbally Identified Gender and the Gender Usage data stored related to the document in question. For example, if the Verbally Identified Gender of the user who initiated the search indicates that that user is a MALE, the Gender Usage data stored for the document in question will compute a frequency of visit score equal to log 2(1+log(VF₁)/log(MAXVF₁) where VF₁ is the number of times that the document was visited (or accessed) in one month by other unique users who had Verbally Identified Gender data identifying them as MALES, and MAXVF₁ is set to 2000. A final frequency of visit score is then computed based upon the first frequency of visit score and the second frequency of visit score, scoring this site based BOTH on the total number of visits as well as the number of visits by MALES, the gender of the user who initiated the search. It should be noted that numerous other factors may be considered in computing visit scores other than Gender. For example the user's age or age grouping may be used to compute a second factor such that Gender and Age may be considered simultaneously in determining the score for a particular user based upon the correlation of both gender and age. In some embodiments of the present invention the age of the user may be determined and/or estimated based upon a voice analysis and/or facial analysis of the user. For example, the paper “A Method for Estimating and Modeling Age and Gender using Facial Image Processing” by J. Hayashi, M. Yasumoto, H. Ito, H. Koshimizu and published in 2001 in the Seventh International Conference on Virtual Systems and Multimedia (VSMM'01), which is hereby incorporated by reference, discloses methods known to the art for both identifying user age as well as a user's gender of users based upon computer processed images of a users face. Note—as used herein, the identification of a user's age by processing of his voice and/or facial image is referred to herein as the Verbally Identified Age of the user.

As for computing visitor frequency values, the following is one method of doing so. VF is computed as being equal to 0.5*(1+UU/MAXUU) where UU is the number of unique visitors that access the document in one month, and MAXUU is set to a reasonable constant such as 400. A small value is used when UU is unknown. VF₁ is computed as being equal to 0.5*(1+UU₁/MAXUU₁) where UU₁ is the number of unique visitors who have Verbally Identified Gender data identifying them as Male that access the document in one month, and MAXUU₁ is set to a reasonable constant such as 400. The number of unique visitors can be determined by monitoring host/IP data and/or other user identification data. The path length score may be computed in a traditional way, for example equal to log(K−PL)/log(K). PL is the number of ‘/’ characters in the document's path, and K is set to 20.

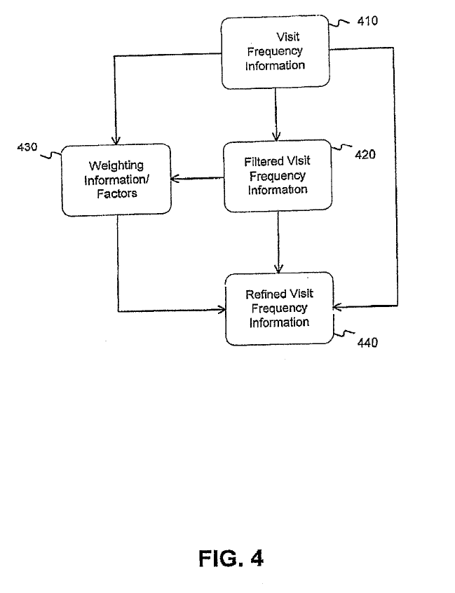

FIG. 4 illustrates a few techniques for computing the frequency of visits to a web document as correlated with the identified gender users who visit the document. The computation begins with one or more counts at 410, one of which may be a raw count and may be an absolute or relative number corresponding to the visit frequency for the document. For example, the raw count may represent the total number of times that a document has been visited. Alternatively, the raw count may represent the number of times that a document has been visited in a given period of time (e.g., over the past week), the change in the number of times that a documents has been visited in a given period of time (e.g., 20% increase during this week compared to the last week), or any number of different ways to measure how frequently a document has been visited. In one implementation, this raw count is used as the refined visit frequency 440, as shown by the path from 410 to 440.

In addition to the raw count as described above at 410, an Identified Gender Count is also available at 410. Each of said counts could be an absolute or relative number corresponding to the visit frequency of users who visited the document of a particular gender or age group respectively. The identified gender of the user may be identified as a result of a voice and/or image processing of the user, in which case it is referred to herein as a Verbally Identified Gender. The identified gender of the user may also be identified in other ways, for example as a result of user response to a query. Either way, an identified gender may be available that indicates the gender of users who visit a particular document. If, for example, the identified gender of a user visiting a specific document is MALE, a gender count associated with the gender MALE would be increased by one. In this way gender count variables can be initialized and incremented, tallying the number of visitors who are identified as a particular gender. Alternatively, the count may represent the number of times that a document has been visited by users who are identified as MALE in a given period of time (e.g., over the past week), the change in the number of times that a documents has been visited by users who are identified as MALE (e.g., 20% increase during this week compared to the last week), or any number of different ways to measure how frequently a document has been visited by users who are identified as male. In one implementation, this count is used as the refined visit frequency. The counting of the total number of visits is described in the previous paragraph as the raw count. The counting of the number of visits as correlated with a particular gender is referred to herein as an identified gender count.

In other implementations, the raw count and/or identified gender count may be processed using any of a variety of techniques to develop a refined visit frequency for each, with a few such techniques being illustrated in FIG. 4. As shown by 420, the raw count and/or identified gender count may be filtered to remove certain visits. For example, one may wish to remove visits by automated agents or by those affiliated with the document at issue, since such visits may be deemed to not represent objective usage. This filtered count 420 may then be used to calculate the refined visit frequency 440.

Instead of, or in addition to, filtering the raw count and/or the identified gender count, the count may be weighted based on the nature of the visit (430). For example, one may wish to assign a weighting factor to a visit based on the geographic source for the visit (e.g., counting a visit from Germany as twice as important as a visit from Antarctica). This weighted visit frequency 430 may then be used as the refined visit frequency 440. Although only a few techniques for computing the visit frequency are illustrated in FIG. 4, those skilled in the art will recognize that there exist other ways for computing the visit frequency, consistent with the invention.

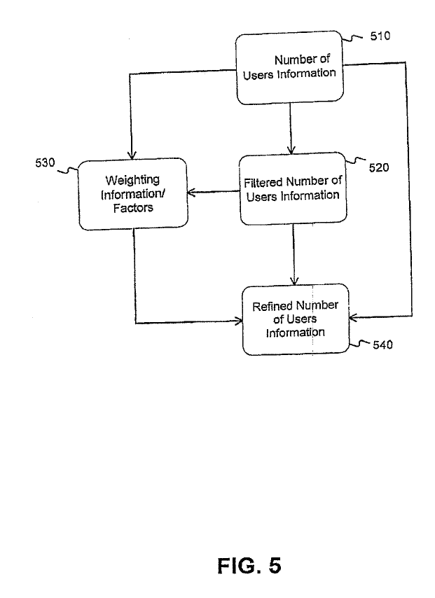

FIG. 5 illustrates a few techniques for computing the total number of unique users as well as the number of unique users of a particular gender. As with the techniques for computing visit frequency illustrated, the computation begins with a one or more counts at 510, one of which may be a raw count and may be an absolute or relative number corresponding to the number of unique users who have visited the document. Alternatively, the raw count may represent the number of unique users that have visited a document in a given period of time (e.g., 30 users over the past week), the change in the number of unique users that have visited the document in a given period of time (e.g., 20% increase during this week compared to the last week), or any number of different ways to measure how many unique users have visited a document. The identification of the unique users may be achieved based on the user's Internet Protocol (IP) address, their hostname, cookie information, or other user or machine identification information. In one implementation, this raw count is used as the refined number of users 540, as shown by the path from 510 to 540.

In addition to the raw count as described above at 510, an Identified Gender Count is also available at 510. These counts may be an absolute or relative number corresponding to the visit frequency of unique users who visited the document who were identified as certain gender. For example if a unique user visiting a specific document is identified as MALE, an identified gender count associated with MALE would be increased by one. In this way identified gender count variables can be initialized and incremented, tallying the number of unique visitors who are male, female, or unknown in gender. For example, the count may represent the total number of times that a document has been visited by unique users who are identified as FEMALE. Alternatively, the count may represent the number of times that a document has been visited by unique users who are identified as FEMALE in a given period of time (e.g., over the past week), the change in the number of times that a documents has been visited by unique users who are identified as FEMALE in a given period of time (e.g., 20% increase during this week compared to the last week), or any number of different ways to measure how the number of times a document has been visited by unique users who are identified as FEMALE. Whereas the counting of the total number of unique visits is described in the previous paragraph as the raw count, the counting of the number of unique visits as correlated with a particular gender is referred to herein as an Identified Gender count.

In other implementations, the raw count and/or identified gender count may be processed using any of a variety of techniques to develop a refined user count for each, with a few such techniques being illustrated in FIG. 5. As shown by 520, the counts may be filtered to remove certain users. For example, one may wish to remove users identified as automated agents or as users affiliated with the document at issue, since such users may be deemed to not provide objective information about the value of the document. This filtered count 520 may then be used to calculate a refined user count 540.

Although only a few techniques for computing the number of unique users are illustrated in FIG. 5, those skilled in the art will recognize that there exist other ways for computing the number of unique users, consistent with the invention. Furthermore, although FIGS. 4 and 5 illustrate determining Gender Usage Data for each document, other techniques may be used. For example, rather than maintaining Gender Usage data for each document, one could maintain such information on a site-by-site basis. This site Gender Usage information could then be associated with some or all of the documents within that site. This reduces the amount of data that must be stored for each site.

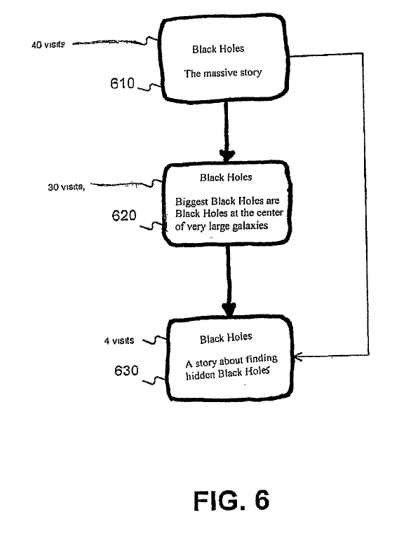

FIG. 6 depicts an exemplary method employing visit frequency information, consistent with the invention. FIG. 6 depicts three documents, 610, 620, and 630, which are responsive to a search query for the term “black holes”.

Document 610 is shown to have been visited 40 times over the past month, with 15 of those 40 visits being by automated agents. Of the 25 non-automated visits, this document is shown to have been visited 10 times by users who have been identified as FEMALE, visited 13 times by users who have been identified as MALE, and two times by users of UNKNOWN gender.

Document 620, which is linked to from document 610, is shown to have been visited 30 times over the past month. Of the 30 visits, this document is shown to have been visited 21 times by users who have been identified as MALE, visited six times by users who have been identified as FEMALE, and visited by three users of UNKNOWN gender.

Document 630, which is linked to from documents 610 and 620, is shown to have been visited four times over the past month. Of the four visits, this document is shown to have been visited one time by a user who was identified as MALE, visited two times by users who have been identified as FEMALE, and visited by one user of UNKNOWN gender.

Under a conventional term frequency based search method, the documents may be organized based on the frequency with which the search query term (“black holes”) appears in the document. Accordingly, the documents may be organized into the following order: 620 (assuming three occurrences of “black holes” were found), 630 (assuming two occurrences of “black holes” were found), and 610 (assuming one occurrence of “black holes” were found).

Under a conventional link-based search method, the documents may be organized based on the number of other documents that link to those documents. Accordingly, the documents may be organized into the following order: 630 (linked to by two other documents), 620 (linked to by one other document), and 610 (linked to by no other documents).

Under a conventional visit count method of organizing documents, the documents may be organized based upon the total number of visits to that site by non-automated agents. Accordingly, the documents may be organized into the following order 620 (visited by 30 non-automated agents), 610 (visited by 25 non-automated agents), then 630 (visited by four non-automated agents).

Methods and apparatus consistent with the invention employ both the Verbally Identified Gender of the user who is performing the search and the stored Gender Usage data associated with retrieved documents to aid in organizing the documents. In this case the methods identify a gender for the user who is currently performing the search by reviewing the Verbally Identified Gender data for that user. This data indicates that the user is MALE. The document may then be organized not based simply upon the number of visits to that document, the number of non-automated visits to that document, or the distribution of visits from various IP addresses in certain locations to that document, but upon the Verbally Identified Gender of the user who is performing the search (in this case MALE) and the number of visits to the document by other users who were also identified as MALE.

Using the correlation between the MALE gender of the user and the number of MALE USER VISITS stored in the Gender Usage Data for each of the documents, the documents may be organized based upon the PECENTAGE_MALE of users who visited each document in the past. Using such a method, the documents may be ordered in the following way: 620 (78% of the users of known gender who have visited the document were identified as male) 610 (57% of the users of known gender who have visited the document were identified as male) and 630 (33% of the users of known gender who have visited the document were identified as male).

Instead of using only the Verbally Identified Gender data of the user and the Gender Usage information for the documents, the gender data may be used in combination with the query information and/or the link information to develop the ultimate organization of the documents.

Gender and Age Combinations:

In some embodiments, both Gender and Age correlations may be used simultaneously to provide an even more refined ordering of documents for a user of a particular age and gender combination. For example, for a MALE user of age group between 19 and 25 years old performs an internet search using the methods disclosed herein. The user's Verbally Identified Age Group and Verbally Identified Gender is correlated with Age Usage Information and Gender Usage Information respectively to determine the level of match between a particular document being ordered and the previous users who were also MALE and of an age group between 18 and 25 years old who accessed that document. Age and Gender matches are a particular useful combination because user preference in documents is often highly correlated with the combined factors of age and gender. For example, MALE users between 8 and 12 years old have unique preferences and perspectives that are very different from FEMALE users between 8 and 12 years old and are also very different from MALE users of other age groups.

User Ratings:

In addition to tracking how many and/or how often users of a particular GENDER accesses a given document or site (as disclosed in the pages above), the invention disclosed herein includes further methods to allow said users to rate websites, said ratings being correlated with the users identified gender. Said ratings can optionally be prompted by the search engine, asking the user to rate the usefulness of the document after it has been reviewed by the user. The rating can be binary (useful/not-useful) or can be given on a continuous rating scale, for example a Usefulness Rating Scale from 1 to 10 (1 being the least useful and 10 being the most useful). In this way a user who is, for example, MALE and who searches for information about EXERCISE can rate each document he reviews, said rating information being added to the Gender Usage Data store for that document. Using the methods and systems disclosed herein, the Gender Usage Data correlates the rating data given by the user with that user's gender. In this way the Gender Usage Data for the Exercise document described in the example above will be updated with the rating information given by MALE users and by female users. For example, the average usefulness rating provided by male users for the Exercise document on a Usefulness Scale from 1 to 10 (with 1 being the least useful and 10 being the most useful) may be 8.5 on the scale. Similarly, the average usefulness rating provided by FEMALE users for the Exercise document on a Usefulness Scale from 1 to 10 (with 1 being the least useful and 10 being the most useful) may be 2.5 on the scale. Thus the document is shown to be found highly useful by male users and minimally useful by female users. This data can be used to strengthen the correlation of this document to MALE identified gender and to weaken the correlation of this document to FEMALE identified gender. For example, the Gender Usage Data representing the relative number or frequency of male visitors may be scaled upward based upon the highly useful rating data provided by male users. Similarly, the Gender Usage Data representing the relative number or frequency of female visitors may be scaled downward based upon the minimally useful rating data provided by female users. In this way rating data provides more accurate means for correlation between Gender Usage Data and Verbally Identified Gender data to predict the usefulness of a given document to a particular user performing a search.

Other Rating Methods:

In some embodiments, other methods may be used to derive “usefulness” rating data other than simply collecting data from the user as a result of a direct query. For example Print Tracking is a technique that may be employed as is disclosed in U.S. Provisional Patent Application No. 60/649,240 which is hereby incorporated by reference. Similarly, Time Spent tracking is a technique that may be employed as is also disclosed in U.S. Provisional Patent Application No. 60/649,240 which is incorporated by reference.

Assigned Gender Correlations:

In addition to, or instead of the forms of Gender Usage data described above for reflecting the number of users and/or frequency of users who have visited a document of a particular identified Gender, an Assigned Gender Correlation may be set for a particular web site or document, said Assigned Gender Correlation reflecting the likely relevance of that site to a user of a particular Gender. For example a website could be assigned a high correlation factor with MALE users. This assigned correlation could be set by an author of the web document, an owner of the web document, the host of the web document, or by some other party. The assigned correlation could be stored on the server along with the document itself or could be stored on a remote server or proxy server. In some embodiments of the invention disclosed herein, the Assigned Gender Correlation is used by the ordering algorithm, more favorably ordering those documents that have an Assigned Gender Correlation that correlate well with Verbally Identified Gender of the user who initiated a given search.

Determining an Effective Gender of a user and optionally overriding the Verbally Identified Gender of that User:

In some situations a user may be assigned a Verbally Identified Gender based upon the processed voice and/or image of the user, but this gender may not always be well correlated with the predicted document preferences of the user. This may be because the user's gender was incorrectly identified by the voice and/or image processing routines. This may also be because not all users behave as predicted by their actual biological gender. In fact some users may behave in ways that are more closely correlated with the opposite gender to their biological gender.

Because the gender related document preferences are derived based upon statistical trends and averages, it will be statistically rare for users to behave significantly outside their biological gender, but still it may be desirable to account for such situations in the methods of the present invention. To account for such situations the methods of the present invention may determine how well a users document visiting habits correlate with his or her Verbally Identified Gender and in response to a negative correlation, adjust the Verbally Identified Gender to match the behavior rather than the data entered by the user.

By correlating the documents that he or she is currently visiting and/or has historically visited with the Gender Usage data for those documents. For example, if a user has recently visited ten web site documents, each of those documents having Gender Usage Data showing a strong correlation with the gender of MALE, the software of the present invention may predict that the current user is effectively MALE even if the Verbally Identified Gender for that user is FEMALE. Furthermore the software of the present invention may override the Verbally Identified Gender of that user by assigning an Effective Gender of that user to MALE. Alternately the software of the present invention may adjust the Gender Correlation Factor for that user to a negative number, reflecting the fact that the Verbally Identified Gender for that user is negatively correlated with the documents that the user is likely to prefer. Similarly, the software of the present invention may adjust the Gender Confidence Value for that user to a lower value, reflecting the fact that the Verbally Identified Gender for that user has an increased likelihood of being incorrect. In this way, a correlation between the documents that a user accesses and the Gender Usage Data for those documents may be used to increase or decrease a Gender Confidence Value generated for a Verbally Identified Gender for that user and/or may be used to adjust a Gender Correlation Factor for that user and/or may be used to override a Verbally Identified Gender with a different Effective Gender.

As an example of this, a user visits a number of documents, each of which is associated with Gender Usage Data including a PERCENT_MALE value for each (this value being percentage of known visitors who were identified as MALE). The software of the present invention then computes an AVERAGE_PERCENT_MALE value across the number of documents that the user visited, the AVERAGE_PERCENT_MALE being the statistical average of the PERCENT_MALE values associated with each of the number of documents visited by the user. If the AVERAGE_PERCENT_MALE across the number of documents visited by the unknown user is significantly greater than 50%, then on average the documents visited by the user are more frequently visited by males and the user's Effective Gender may be determined to be MALE by the software of the present invention. If the AVERAGE_PERCENT_MALE across the number of documents visited by the unknown user is significantly less than 50%, then on average the documents visited by the user are more frequently visited by females and the user's Effective Gender may be predicted as FEMALE by the software of the present invention. If the user's Effective Gender is determined to be different than the user's Verbally Identified Gender, the Gender Correlation Factor for that user may be decreased, reflecting lower confidence in the verbal gender identification, the amount of the decrease being dependent upon how much more or less than 50% the AVERAGE_PERCENT_MALE value was computed as. Conversely, if the user's Effective Gender is determined to be the same than the user's Verbally Identified Gender, then the Gender Correlation Factor for that user may be increased, reflecting higher confidence in the verbal identification, the amount of the increase being dependent upon how much more or less than 50% the AVERAGE_PERCENT_MALE value was computed as. In addition, if the Effective Gender is determined to be different than the user's Verbally Identified Gender, the Gender Correlation Value may be adjusted to reflect a lower correlation, even a negative correlation, between Verbally Identified Gender and the predicted gender-based document preferences of the user. Thus the present invention provides for methods of using Gender Usage Data to refine a gender determination made using verbal utterances and/or image data collected from a user.

While the invention herein disclosed has been described by means of specific embodiments, examples and applications thereof, numerous modifications and variations could be made thereto by those skilled in the art without departing from the scope of the invention set forth in the claims.

What is claimed is:

1. A computer implemented method of organizing a set of documents, comprising:
receiving verbal utterances from a user;
processing the verbal utterances using gender analysis routines, thereby determining a verbally identified gender of the user;
processing the verbal utterances using speech recognition routines, thereby determining the content of a search query uttered by the user;
identifying a set of documents responsive to the search query based at least in part upon the content of the search query uttered by the user;
assigning a score to each identified document based upon a correlation between gender-usage data for each document in the set and the verbally identified gender of the user, the gender-usage data describing at least one of a number and frequency of users who have previously accessed the document who are of a particular gender; and
organizing the documents based at least in part on the score.

2. The computer implemented method of claim 1 wherein the gender-usage data describes a number of users of the particular gender who accessed the document during a predetermined period of time.

3. The computer implemented method of claim 1 wherein the gender-usage data describes a frequency with which users of the particular gender accessed the document during a predetermined period of time.

4. The computer implemented method of claim 1 wherein
the verbally identified gender further includes a gender-correlation factor of the user, the gender-correlation factor indicating a degree of statistical relevance that gender has for predicting a document preference for the user; and
assigning a score to each identified document further comprises assigning the score based in part upon the gender-correlation factor.

5. The computer implemented method of claim 4 further comprising adjusting the gender-correlation factor based on document viewing behavior of the user.

6. The computer implemented method of claim 1 wherein the verbally identified gender includes a gender-confidence value indicating a degree of confidence in the verbally identified gender of the user.

7. The computer implemented method of claim 6 wherein assigning a score to each identified document further comprises assigning the score based in part upon the gender-confidence value.

8. The computer implemented method of claim 1 further comprising:
correlating the gender-usage data for each document with rating data for that document, the rating data indicating a level of usefulness of the identified document to one or more previous users who accessed the document and who are of the particular gender, wherein
assigning a score to each identified document further comprises assigning the score to each identified document based upon the correlation between the rating data for each document and the identified-gender data.

9. The computer implemented method of claim 8 further comprising receiving the rating data from the user.

10. The computer implemented method of claim 8 further comprising deriving the rating data from actions of the user.

11. The computer implemented method of claim 1 further comprising: obtaining identified-age data for the user, the identified-age data including information describing a presumed age of the user, wherein assigning a score to each identified document further comprises assigning the score based upon a correlation between age-usage data for each document and the identified-age data for the user, the age-usage data for each document describing at least one of a number and frequency of users who have previously accessed the document who are of a particular age, age range, or age grouping.

12. The computer implemented method of claim 11 wherein the identified age data is determined based at least in part upon at least one of a voice analysis of the verbal utterance from the user and a facial analysis of facial image data of the user.

13. An apparatus for organizing a collection of documents comprising:
circuitry having executable instructions; and
at least one processor configured to execute the instructions to perform operations of:
receiving verbal utterances from a user;
processing the verbal utterances using gender analysis routines, thereby determining a verbally identified gender of the user;
processing the verbal utterances using speech recognition routines, thereby determining the content of a search query uttered by the user;
identifying a set of documents responsive to the search query based at least in part upon the content of the search query uttered by the user;
assigning a score to each identified document based upon a correlation between gender-usage data for each document in the set and the verbally identified gender of the user, the gender-usage data having been determined at least in part based on at least one of a number and frequency of users who have previously accessed the document who are of a particular gender; and
organizing the documents based at least in part on the score.

14. The apparatus of claim 13 wherein the gender-usage data describes a number of users of the particular gender who accessed the document during a predetermined period of time.

15. The apparatus of claim 13 wherein the gender-usage data describes a frequency with which users of the particular gender accessed the document during a predetermined period of time.

16. The apparatus of claim 13 wherein
the verbally identified gender further includes a gender-correlation factor of the user, the gender-correlation factor indicating a degree of statistical relevance that gender has for predicting a document preference for the user; and
assigning a score to each identified document further comprises assigning the score based in part upon the gender-correlation factor.

17. The apparatus of claim 13 wherein the verbally identified gender includes a gender-confidence value indicating a degree of confidence in the verbally identified gender of the user.

18. A computer implemented method of organizing a set of documents, comprising:
receiving verbal utterances from a user;
processing the verbal utterances using gender analysis routines, thereby determining a verbally identified gender of the user;
receiving a search query from a user in either a verbal or textual form;
identifying a set of documents responsive to the search query;
assigning a score to each identified document based upon a correlation between gender-usage data for each document in the set and the verbally identified gender of the user, the gender-usage data describing prior usage of the document by users who are of a particular gender; and
organizing the documents based at least in part on the score.

19. The computer implemented method of claim 18 wherein the gender-usage data describes a number of users of the particular gender who accessed the document during a predetermined period of time.

20. The computer implemented method of claim 18 wherein the gender-usage data describes a frequency with which users of the particular gender accessed the document during a predetermined period of time.

21. The computer implemented method of claim 18 wherein
the verbally identified gender further includes a gender-correlation factor of the user, the gender-correlation factor indicating a degree of statistical relevance that gender has for predicting a document preference for the user; and
assigning a score to each identified document further comprises assigning the score based in part upon the gender-correlation factor.
